(19) United States
(12) Patent Application Publication
(10) Pub. No.: US 2007/0109437 A1
(43) Pub. Date: May 17, 2007

(54) Solid state image sensing device

(75) Inventors: Masaki Funaki, Chiba-Ken (JP); Takeshi Shimizu, Tokyo-To (JP)

Correspondence Address: RENNER, KENNER, GREIVE, BOBAK, TAYLOR & WEBER, FIRST NATIONAL TOWER FOURTH FLOOR, 106 S. MAIN STREET, AKRON, OH, 44308, US

(73) Assignee: Victor Company of Japan, Ltd., a corporation of Japan, Yokohama-Shi (JP)

(21) Appl. No.: 11/599,867

(22) Filed: Nov. 15, 2006

(30) Foreign Application Priority Data
Nov. 15, 2005 (JP) 2005-330671

(51) Int. Cl. H04N 5/335

(52) U.S. Cl. 348/308

(57) ABSTRACT

A solid state image sensing device includes: a substrate of a first conductive type, a first well and at least one second well formed on the substrate, a pixel area with multiple pixels provided in the first well, a charge transferee, provided for each pixel, for charge transfer, and MOS-type circuitry provided in the second well. The first and second wells are of a second conductive type different from the first conductive type. The first and second wells are isolated from each other. The second well is formed with higher impurity concentration than the first well. The pixel area has at least a photoelectric conversion region of the first conductive type, provided for each pixel, for storing charges generated due to photoelectric conversion, a source region, and a drain region. The source and drain regions are provided for a signal output transistor, provided for each pixel, that outputs a signal based on the charges.

### CROSS-REFERENCE TO RELATED APPLICATIONS

This application is based on and claims the benefit of priority from the prior Japanese Patent Application No. 2005-330671 filed on Nov. 15, 2005, the entire content of which is incorporated herein by reference.

### BACKGROUND OF THE INVENTION

The present invention relates to a solid state image sensing device equipped with a CMOS image sensor.

Solid state image sensing devices equipped with a CMOS image sensor are known as superior to th0se with a CCD image sensor, for higher operating frequency and lower power consumption.

There are two types of CMOS image sensors used in solid state image sensing devices: one having a function as a rolling shutter and the other as a global shutter, such as th0se disc1osed in Japanese Unexamined Patent Publication Nos. 2003-17677 and 2004-55590, respectively.

The rolling-shutter type CMOS image sensor reads out charges stored in photodiodes provided as photoreceptors line by line, thus suffering off timing between the first and last lines in one frame and hence pictures being distorted when imaging a moving object.

In contrast, the global-shutter type CMOS image sensor reads out charges stored in photodiodes simultaneously for all lines in one frame, thus overcoming the problem for the rolling-shutter type, nevertheless, having a problem of insufficient noise reduction performance.

### SUMMARY OF THE INVENTION

A purpose of the present invention is to provide a solid state image sensing device equipped with a CMOS image sensor with higher photoelectric conversion efficiency and higher image quality.

Another purpose of the present invention is to provide a solid state image sensing device equipped with a CMOS image sensor having a function as a global-shutter, suitable for imaging a moving object.

Still another purpose of the present invention is to provide an advanced structure for MOS-type transistors and circuitry, particularly, applicable to a solid state image sensing device.

The present invention provides a solid state image sensing device comprising: a substrate of a first conductive type; a first well and at least one second well formed on the substrate, the first and second wells being of a second conductive type different from the first conductive type, the first and second wells being isolated from each other, the second well being formed with higher impurity concentration than the first well; a pixel area with multiple pixels provided in the first well, the pixel area including at least a photoelectric conversion region of the first conductive type, provided for each pixel, for storing charges generated due to photoelectric conversion, a source region, and a drain region, the source and drain regions being provided for a signal output transistor, provided for each pixel, that outputs a signal based on the charges; a charge transferee, provided for each pixel, for transferring the charges to the signal output transistor; and MOS-type circuitry provided in the second well.

### BRIEF DESCRIPTION OF DRAWINGS

FIG. 1 shows a block diagram of a preferred embodiment of a solid state image sensing device according to the present invention;

FIG. 2 shows a schematic cross section of the solid state image sensing device taken on line H-H′ in FIG. 1;

FIG. 3 shows a schematic cross section of the solid state image sensing device taken on line Y-Y′ in FIG. 1;

FIG. 4 shows a schematic cross section of the solid state image sensing device taken on line Z-Z′ in FIG. 1;

FIG. 5 shows a schematic cross section of the solid state image sensing device taken on line V-V′ in FIG. 1;

FIG. 6 shows a schematic plan view and a schematic sectional view taken on line X-X′ in the plan view, of a structure of each pixel in a preferred embodiment of a solid state image sensing device according to the present invention;

FIG. 7 shows an electrical block diagram with equivalent circuitry, indicating the entire structure of a solid state image sensing device and the structure of each pixel in a CMOS image sensor of the device, according to the present invention; and

FIG. 8 shows a timing chart indicating the operation of the CMOS image sensor shown in FIG. 7 according to the present invention.

### DETAILED DESCRIPTION OF PREFERRED EMBODIMENTS

Preferred embodiments of a solid state image sensing device according to the present invention will be disc1osed.

The same reference signs or numerals are generally given to the same or analogous elements or components throughout the drawings.

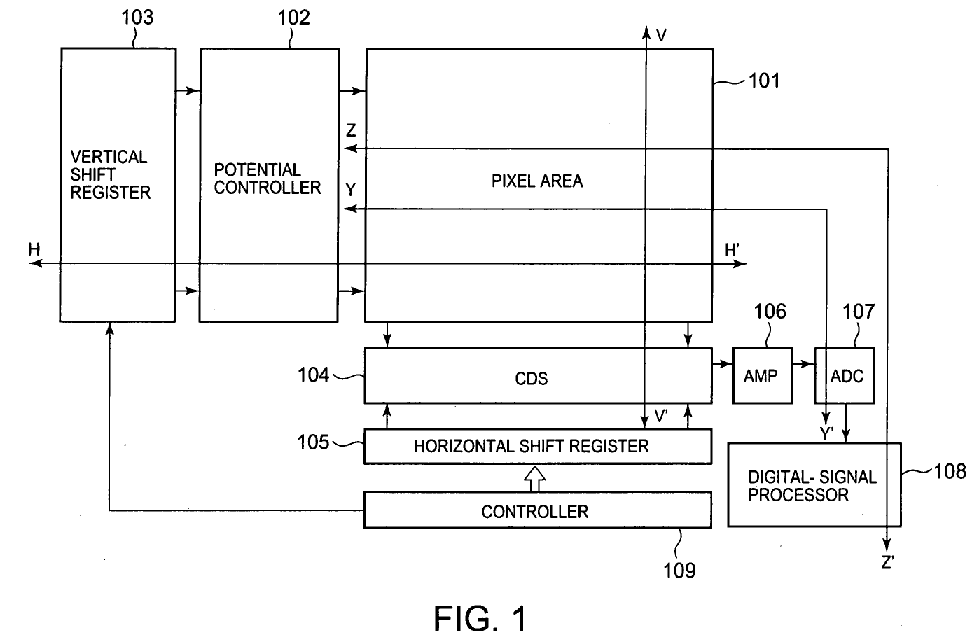

FIG. 1 shows a block diagram of a preferred embodiment of a solid state image sensing device according to the present invention. As shown, the solid state image sensing device is provided with: a pixel area 101 arranged in which are multiple pixels for photoelectric conversion; a potential controller 102 for driving the pixels; a vertical shift register 103 for controlling the controller 102; a CDS unit 104 for processing signals from the pixels with a CDS (Correlated Double Sampling) operation; a horizontal shift register 105 for controlling the CDS unit 104; an amplifier (AMP) 106 for processing signals from the CDS unit 104 with amplification and other necessary operations; an ADC (Analog-to-Digital Converter) unit 107 for converting signals from the amplifier 106 into digital signals; a digital-signal processor 108 for processing digital signals from the ADC unit 107 with necessary operations, such as, signal-level, pixel-defect correction, etc; and a controller 109 for controlling the solid state image sensing device while generating several control signals to the respective circuitry, with built-in interface circuitry (not shown), for external settings to the controller 109 and the respective circuitry.

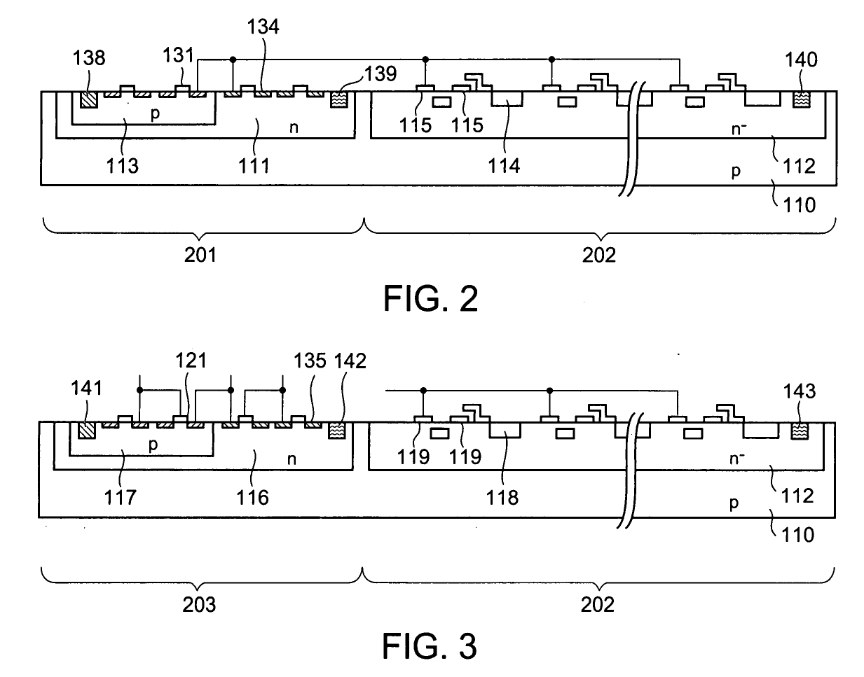

FIG. 2 shows a schematic cross section of the solid state image sensing device taken on line H-H′ in FIG. 1. As shown, there are two areas in the cross section: a drive/control circuitry area 201 corresponding to the drive/control circuitry area for the potential controller 102 and the vertical shift register 103; and a pixel area 202 corresponding to the pixel area 101. The areas 201 and 202 are provided on a p₋type substrate 110, having an n-well 111 and an n⁻-well 112, respectively, formed on the substrate surface, with a p-well 113 in the n-well 111, thus constituting a triple-well structure.

Formed in the n-well 111 of the drive/control circuitry area 201 are p₋type source/drain diffusion regions 134, an n-well contact 139, etc. Formed in the p-well 113 of the n-well 111 are gate circuitry 131, a p-well contact 138, etc. Formed in the n⁻-well 112 of the pixel area 202 are a buried p⁻-type region 114 (for photoelectric conversion), source/drain regions, an n-well contact 140, etc. Formed on the n⁻-well 112 is a ring gate electrode 115 electrically connected to the drive/control circuitry area 201, under control by the drive/control circuitry.

The drive/control circuitry area 201 and the pixel area 202 are provided on the p₋type substrate 110 as being isolated from each other to protect signals flowing through the area 202 from noises generated in the area 201. Such noises are generated due, for example, to switching in the gate circuitry 131 and transferred into the n-well 111 in the area 201 due to parasitic capacitive coupling. The noises are connected to an external power supply through the n-well contact 139 by which a potential of the n-well 111 is to be fixed. The noise level varies due to the resistance of the n-well 111, not fixed at the supply level.

If a single well were shared by both of the n-well 111 in the drive/control circuitry area 201 and the n⁻-well 112 in the pixel area 202, such noise variation discussed above would be transferred to the pixel area 202 and affect a signal photoelectrically converted in the p₋type region 114 in each pixel.

In order to avoid such adverse effects, two n-wells, i. e., the n-well 111 and the n⁻-well 112, are provided as isolated from each other, as shown in FIG. 2, while the p₋type substrate 110 is fixed at a given potential. Such arrangements prevent potential variation in the n-well 111 of the drive/control circuitry area 201 from being transferred to the pixel area 202, thus minimizing the above-mentioned adverse effects to the pixel area 202 due to parasitic capacitive coupling.

Lower well dopant concentration enhances photoelectric conversion efficiency. Thus, in this embodiment, the well dopant concentration is lowered for the the n⁻-well 112 of the pixel area 202 compared to the n-well 111 of the drive/control circuitry area 201.

FIG. 3 shows a schematic cross section of the solid state image sensing device taken on line Y-Y′ in FIG. 1. As shown, there are two areas in the cross section: the pixel area 202 and an ADC circuitry area 203 corresponding to the ADC unit 107. The areas 202 and 203 are provided on the p₋type substrate 110, not electrically connected to each other, having the n⁻-well 112 and an n-well 116, respectively, formed on the substrate surface, with a p-well 117 in the n-well 116, thus constituting a triple-well structure.

Formed in the n-well 116 of the ADC circuitry area 203 are p₋type source/drain diffusion regions 135, an n-well contact 142, etc. Formed in the p-well 117 of the n-well 116 are gate circuitry 121, a p-well contact 141, etc.

Formed in the n⁻-well 112 of the pixel area 202 are a buried p₋type region 118 (for photoelectric conversion), source/drain regions, an n-well contact 143, etc. Formed on the n⁻-well 112 is a ring gate electrode 119, etc.

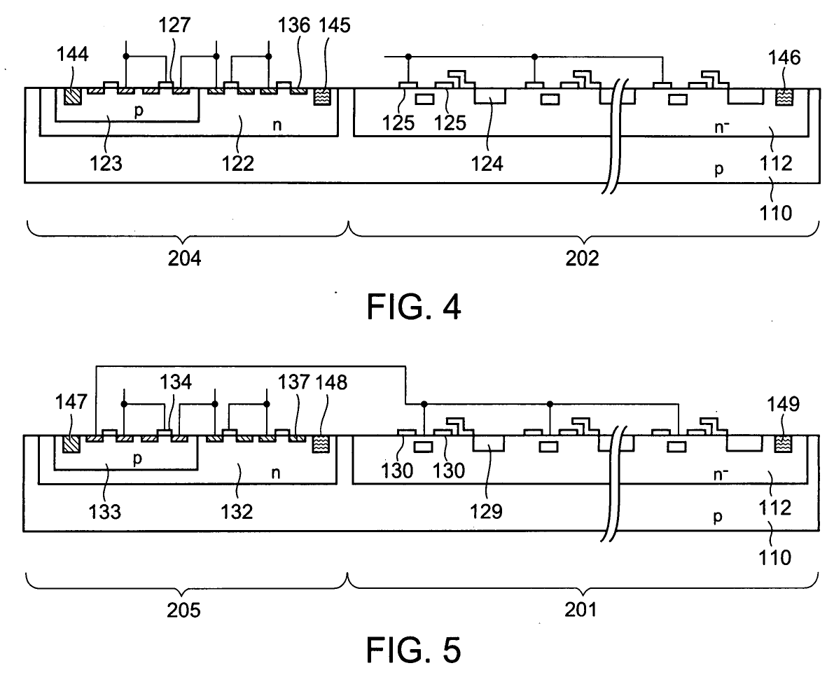

FIG. 4 shows a schematic cross section of the solid state image sensing device taken on line Z-Z′ in FIG. 1. As shown, there are two areas in the cross section: the pixel area 202 and a signal processing circuitry area 204 corresponding to the digital-signal processor 108. The areas 202 and 204 are provided on the p₋type substrate 110, not electrically connected to each other, having the n⁻-well 112 and an n-well 122, respectively, formed on the substrate surface, with a p-well 123 in the n-well 122, thus constituting a triple-well structure.

Formed in the n-well 122 of the signal processing circuitry area 204 are p₋type source/drain diffusion regions 136, an n-well contact 145, etc. Formed in the p-well 123 of the n-well 122 are gate circuitry 127, a p-well contact 144, etc.

Formed in the n⁻-well 112 of the pixel area 202 are a buried p₋type region 124 (for photoelectric conversion), source/drain regions, an n-well contact 146, etc. Formed on the n⁻-well 112 is a ring gate electrode 125, etc.

FIG. 5 shows a schematic cross section of the solid state image sensing device taken on line V-V′ in FIG. 1. As shown, there are two areas in the cross section: the pixel area 202 and a CDS circuitry area 205 corresponding to the CDS unit 104. The areas 202 and 205 are provided on the p₋type substrate 110, electrically connected to each other, having the n⁻-well 112 and an n-well 132, respectively, formed on the substrate surface, with a p-well 133 in the n-well 132, thus constituting a triple-well structure.

Formed in the n-well 132 of the CDS circuitry area 205 are p₋type source/drain diffusion regions 137, an n-well contact 148, etc. Formed in the p-well 133 of the n-well 132 are gate circuitry 134, a p-well contact 147, etc.

Formed in the n⁻-well 112 of the pixel area 202 are a buried p₋type region 129 (for photoelectric conversion), source/drain regions, an n-well contact 149, etc. Formed on the n⁻-well 112 is a ring gate electrode 130, etc.

In the same manner as discussed with respect to FIG. 2, for noise protection, two n-wells are provided as isolated from each other, for the pixel area 202 and the circuitry area, such as, the ADC circuitry area 203, the signal processing circuitry area 204, and the CDS circuitry area 205, as shown in FIGS. 3, 4 and 5, respectively. The circuitry areas 203 to 205 are occasionally referred to as pixel peripheral circuitry areas 203 to 205 in the following description.

Circuitry in each of the pixel peripheral circuitry areas 203 to 205 is required to operate at several ten MHz while the pixel area 202 at several MHz. The areas 203 to 205 thus require a process rule for further microfabrication than that for the pixel area 202.

In other words, a process rule for further microfabrication provides higher operating frequency. In detail, further microfabrication provides shorter gate electrode or shorter gate length for MOSFETs. Shorter gate length gives higher transistor mutual conductance (gm) to allow further current flow for quicker charging to the succeeding transistor, thus resulting in higher operating frequency. Nevertheless, shorter gate length develops short-channel effect while reduces device isolation effect. Improvements to these effects require higher well impurity concentration.

Such a process rule for further microfabrication and well impurity concentration follow a scaling law. In other words, a gate length suggests a process rule employed in device fabrication, under a scaling law.

For example, in FIGS. 2 to 5, the pixel area 202 is formed under 0.35-μm rule whereas the pixel peripheral circuitry areas 203 to 205 under 0.25-μm rule, because the areas 203 to 205 operate at higher frequency than the area 202. MOSFETs produced under these process rules have a gate length of about 0.35 μm in the area 202 whereas about 0.25 μm in the areas 203 to 205, and well impurity concentration in the range from about 1×10¹⁶ to 1×10¹⁷ cm⁻³ in the area 202 whereas about 1×10¹⁷ to 7×10¹⁷ cm⁻³ in the areas 203 to 205.

Therefore, these process rules offer higher well impurity concentration to the pixel peripheral circuitry areas 203 to 205 than the pixel area 202. Such difference in well impurity concentration allows the areas 203 to 205 to operate at 50 MHz whereas the area 202 at 10 MHz, for example. In other words, the areas 203 to 205 require higher well impurity concentration than the area 202 to operate at higher frequency.

Moreover, a process rule, such as 0.35-μm rule for longer gate length, for the pixel area 202, offers larger MOSFETs for amplification in the initial-stage amplifier, thus providing a noise-less solid image state image sensing device, because the larger the transistor, the lower the 1/f noise (f: a frequency component of an output signal) in MOSFET.

The drive/control circuitry area 201 does not require such a process rule for further microfabrication required for the pixel peripheral circuitry areas 203 to 205 because the former area needs not operate at such a higher frequency for the latter areas.

Nevertheless, it is inefficient to apply different process rules to the drive/control circuitry area 201 and the pixel peripheral circuitry areas 203 to 205. The same process rule for further microfabrication is thus applied to all of the areas 201 and 203 to 205, with the same higher well concentration to all of these areas. The n- and p-wells in these areas are isolated from each other so that neither well does not suffer from adverse noise effects.

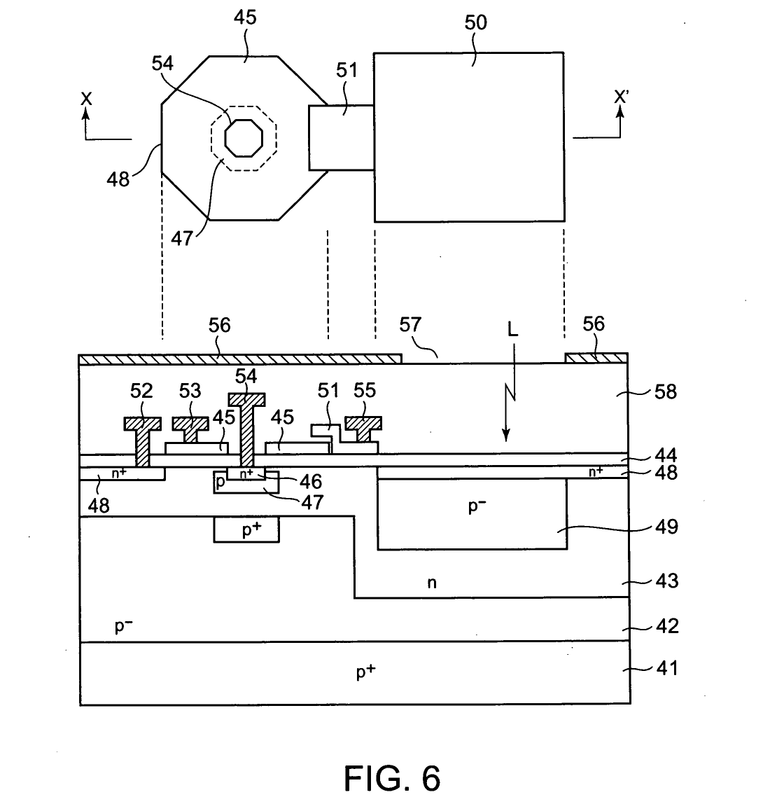

Disc1osed next is a structure and an operation of each pixel in the pixel area 101 (202), with respect to FIG. 6. The figure shows a upper schematic plan view and a lower schematic sectional view (taken on line X-X′ in the plan view) of a structure of each pixel in a preferred embodiment of a solid state image sensing device according to the present invention.

A solid state image sensing device in this embodiment, shown in FIG. 6 is a CMOS image sensor having a function as a global shutter.

Grown on a p⁺-type substrate 41 is a p⁻-type epitaxial layer 42 having an n-well 43 formed thereon. Formed over the n-well 43 via a gate oxide film (an insulating film) 44 is a gate electrode 45 having a ring top. The n-well 43 corresponds to the n⁻-well 112 while the gate electrode 45 to the ring gate electrodes 115, 119, 125 and 130 in FIGS. 2 to 5, respectively.

Formed on a surface portion of the n-well 43, corresponding to the center portion of the ring gate electrode 45, is an n⁺-type source region 46 with a p₋type region 47 formed in the vicinity of the source region 46. The p₋type region 47 is referred to as a source-vicinity p₋type region 47 in the following description. Formed as apart from the n⁺-type source region 46 and the source-vicinity p₋type region 47 is an n⁺-type drain region 48 with a buried p⁻-type region 49 formed in the n-well 43 under the drain region 48. The buried p⁻-type region 49 (corresponding to the buried p⁻-type regions 114, 118, 124, and 129 in FIGS. 2 to 5, respectively) and the n-well 43 constitute a buried photodiode 50 shown in FIG. 6.

Provided between the buried photodiode 50 and the ring gate electrode 45 is a transfer gate electrode 51, as shown in FIG. 6. Connected as metal wirings to the drain region 48, the ring gate electrode 45, the source region 46, and the transfer gate electrode 51 are a drain electrode wiring 52, a ring gate electrode wiring 53, a source electrode wiring 54 (output wiring), and a transfer gate electrode wiring 55, respectively.

Formed over these components via an insulating film 58 is a light shading film 56 having an opening 57 provided at the location corresponding to the buried photodiode 50. The light shading film 56 is made from, a metal, an organic film, etc. Light L reaches the buried photodiode 50 through the opening 57 for photoelectric conversion.

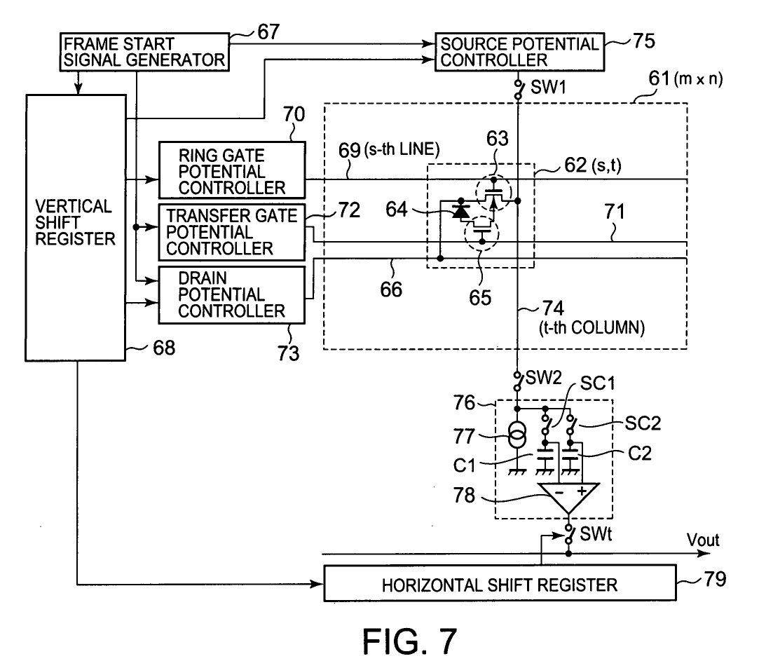

Disc1osed next with respect to FIG. 7 (an electrical block diagram with equivalent circuitry) is the entire structure of a solid state image sensing device and the structure of each pixel in a CMOS image sensor of the device, according to the present invention.

Multiple pixels are arranged in a pixel area 61 (corresponding to the pixel area 101 in FIG. 1) in “m” lines and “n” columns (“m” and “n” being positive integers). Shown in FIG. 7 with an equivalent circuit is a pixel 62 provided at an “s”-th line and a “t”-th column (“s” and “t” being positive integers, smaller than “m” and “n”, respectively), as a representative pixel. The following description focuses on the pixel 62, the same being applied to all pixels in the “m” lines and “n” columns.

The pixel 62 includes an MOSFET 63 having a ring gate electrode, a photodiode 64, and another MOSFET 65 having a transfer gate electrode. The drain electrode of the MOSFET 63 is connected to the cath0de of the photodiode 64 and a drain electrode wiring 66 (corresponding to the wiring 52 in FIG. 6). The source and drain of the MOSFET 65 are connected to the anode of the photodiode 64 and the backgate of the MOSFET 63, respectively.

The MOSFET 63 and MOSFET 65 are referred to as a ring-gate MOSFET 63 and a transfer-gate MOSFET 65, respectively, in the following description.

The ring-gate MOSFET 63 corresponds to an “n”-channel MOSFET, in FIG. 6, that has the source-vicinity p₋type region 47 (gate region), the n⁺-type source region 46, and the n⁺-type drain region 48, directly under the ring gate electrode 45.

The transfer-gate MOSFET 65 corresponds to a “p”-channel MOSFET, in FIG. 6, that has the n-well 43 (gate region), the buried p⁻-type region 49 (source region) of the photodiode 50, and the source-vicinity p₋type region 47 (drain region).

The solid state image sensing device (CMOS image sensor) shown in FIG. 7 is equipped with a frame start signal generator 67 that generates a frame start signal for the start of signal reading for one frame from pixels in the “m” lines and “n” columns. Optionally, such a frame start signal may be provided externally. The frame start signal is supplied to a vertical shift register 68 that outputs signals for reading signals from pixels, for example, the pixels on the “s”-th line.

In the pixel 62 on the “s”-th line: the ring gate electrode of the ring-gate MOSFET 63 is connected to a ring gate potential controller 70 through a ring gate wiring 69; the transfer gate electrode of the transfer-gate MOSFET 65 to a transfer gate potential controller 72 through a transfer gate wiring 71; and the drain electrode of the ring-gate MOSFET 63 to a drain potential controller 73 through a drain gate wiring 66. The ring gate wiring 69, the transfer gate wiring 71, and the drain gate wiring 66 correspond to the wirings 53, 55, and 52, respectively, in FIG. 6. The output signals from the shift register 68 are supplied to these controllers 70, 72 and 73.

In FIG. 7, multiple ring gate electrodes of ring-gate MOSFETs 63 are horizontally wired through the ring gate wiring 69 so that they are controlled by the ring gate potential controller 70 for each line. In contrast, multiple transfer gate electrodes of transfer-gate MOSFETs 65 may be horizontally (as shown in FIG. 7) or vertically wired through the transfer gate wiring 71 because they are controlled by the transfer gate potential controller 72 simultaneously for all of the pixels arranged in the “m” lines and “n” columns in the pixel area 61. The drain potential controller 73 is connected to the frame start signal generator 67 and also the vertical shift register 68 for simultaneous control of all of the pixels or control per line (optional).

The source electrode of the ring-gate MOSFET 63 in the pixel 62 is connected, through a source electrode wiring 74 (a signal output line, corresponding to the wiring 54 in FIG. 6) to a source potential controller 75 via a switch SW1 and also to a signal reader 76 via a switch SW2. The switch SW1 is turned off while the switch SW2 on in signal reading whereas the former on while the latter off in source-potential control. Multiple source electrodes of ring-gate MOSFETs 63 are connected vertically through the source electrode wiring 74 for vertical signal transfer.

The source electrode of the ring-gate MOSFET 63 in the pixel 62 is connected, through the source electrode wiring 74 (signal output line), to a load, for example, a current source 77 of the signal reader 76 via the switch SW2, constituting a source follower. Connected to the current source 77 are capacitors C1 and C2 via switches sc1 and sc2, respectively. The capacitors C1 and C2 are connected to a differential amplifier 78 at inverting and non-inverting terminals, respectively, a potential difference between the capacitors Cl and C2 being output via the amplifier 78.

The circuitry of the signal reader 76, such as shown in FIG. 7, is referred to as CDS (Correlated Double Sampling) which is achieved with not only the one shown in FIG. 7 but also several types of circuitry.

The signal generated by the signal reader 76 is output (Vout) via an output switch swt. Multiple output switches swt provided on each column are controlled by a signal supplied from a horizontal shift register 79.

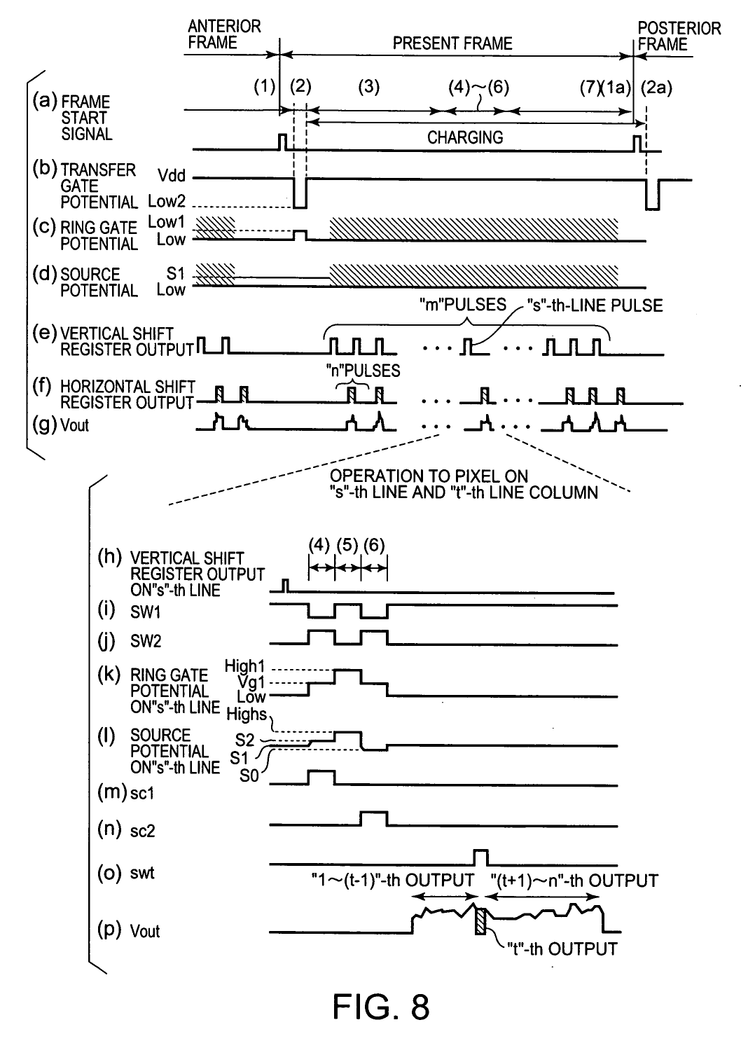

The operation of the CMOS image sensor (FIG. 7) is disc1osed with reference to the timing chart shown in FIG. 8. The following disc1osure generally focuses on charging, transferring and reading operations to the pixel 62 (FIG. 7) located on the s-th line and t-th column for the present one frame, the same being applied to all pixels in the “m” lines and “n” columns.

During a period (1) in FIG. 8, light L is incident to the buried photodiode 50 (FIG. 6) or 64 (FIG. 7), electron-hole pairs being generated due to photoelectric conversion, and holes thus generated being stored in the buried p⁻-type region 49 (FIG. 6) of the photodiode. The transfer-gate MOSFET 65 is off, during the period (1), with the transfer gate electrode 51 at a drain potential Vdd, as shown in (b) of FIG. 8. The holes are stored simultaneously with a signal reading operation to an anterior frame.

On completion of the reading operation to the anterior frame, a frame start signal is generated, as shown in (a) of FIG. 8, for the start of a reading operation to the present frame. During a period (2) in FIG. 8, a transfer gate control signal output from the transfer gate potential controller 72 drops from Vdd to Low2 to lower the potential at the transfer gate electrode 51 (FIG. 6) to Low2 to turn on the transfer-gate MOSFET 65. Holes stored during the period (1) in FIG. 8 are transferred from the buried photodiode 50 (FIG. 6) or 64 (FIG. 7) to the source-vicinity p₋type region 47 (FIG. 6) via the turned-on transfer-gate MOSFET 65 simultaneously for all pixels. Also during the period (2), a potential at the ring gate wiring 69 under control by the ring gate potential controller 70 rises from Low to Low1, as shown in (c) of FIG. 8, but lower than Low2 at the transfer gate electrode 51. The potential Low1 may be equal to Low which may be zero volts.

A potential at the source of the ring-gate MOSFET 63 supplied from the source potential controller 75 through the switch SW1 and source electrode wiring 74 is set to SI higher than Low1, as shown in (d) of FIG. 8, for all pixels. The potential Si keeps the ring-gate MOSFET 63 in a turned-off state with no current flowing therethrough. The turned-off MOSFET 63 allows charges (holes) stored in the photodiode 50 (FIG. 6) or 64 (FIG. 7) to be transferred to under the ring gate electrode 45 (FIG. 6) simultaneously for all pixels.

In FIG. 6, the source-vicinity p₋type region 47 has the lowest potential among the regions under the ring gate electrode 45. Thus, the holes stored in the photodiode 50 (FIG. 6) or 64 (FIG. 7) reach the region 47 and are stored therein. The holes stored in the region 47 then raise the potential at this region.

Next, during a period (3) in FIG. 8, the potential at the transfer gate electrode 51 (FIG. 6) returns to Vdd from Low2 to turn off the transfer-gate MOSFET 65. The turned-off MOSFET 65 allows electron-hole pairs to be generated again due to photoelectric conversion for a posterior frame, and holes (charges) thus generated being stored in the buried p⁻-type region 49 of the photodiode 50 (FIG. 6) or 64 (FIG. 7). This charging operation continues until the next charge transfer operation in a period (2a) in FIG. 8 for the posterior frame.

Also, during the period (3) in FIG. 8, signals are read from the pixels on the 1st to (s−1)-th lines. During this line-by-line signal reading operation, the potential at the ring gate electrode 45 (FIG. 6) of the ring-gate MOSFET 63 (FIG. 7) is at Low, as shown in (c) of FIG. 8, for the pixel 62 on the s-th line and t-th column, with the stored holes remaining in the source-vicinity p₋type region 47 shown in FIG. 6 (a waiting mode). When considering the entire pixels, the potential at the ring gate electrode 45 of the MOSFET 63 depends on lines, as indicated by a shaded zone in (c) of FIG. 8. However, for the pixels on the s-th line, the gate potential is set at Low so that the MOSFET 63 is turned off in the waiting mode, because multiple gate electrodes 45 are connected to one another by the ring gate wiring 69 (FIG. 7) for all pixels on the s-th line. In contrast, the potential at the source electrode of the MOSFET 63 depends on columns, as indicated by a shaded zone in (d) of FIG. 8. In detail, for any pixel on the t-th column, the source potential (MOSFET 63) becomes equal to that at the pixel 62 in the waiting mode, because multiple source electrodes are connected to one another by the source electrode wiring 62 (FIG. 7) for all pixels on the t-th column. Different from the pixels on the t-th column, the pixels on the s-th line take various source potentials different from that at the pixels 62 on the s-th line in the waiting mode, or the source potentials at pixels on the same line depend on which column is subjected to a reading operation.

Next, during periods (4) to (6) in FIG. 8, signals are read from the pixels on the s-th line. This signal reading operation is described for the pixel 62 provided at the s-th line and t-th column, with respect to (h) to (p) of FIG. 8.

In detail, the potential at the ring gate electrode 45 (FIG. 6) of the ring-gate MOSFET 63 (FIG. 7) is raised to Vg1 from Low, as shown in (k) of FIG. 8. This potential increase is triggered by a control signal supplied from the ring gate potential controller 70 through the ring gate wiring 69. This happens during the period (4) in which the vertical shift register 68 is outputting a low-level signal, as shown in (h) of FIG. 8, for the s-th line while the holes have been stored in the source-vicinity p₋type region 47 in FIG. 6.

The potentials Low, Low1, Vg1, and Vdd discussed above satisfy the relation: Low≦Low1≦Vg1≦Vdd (Low≦Vdd).

During the period (4), the switches SW1, SW2, sc1, and sc2 shown in FIG. 7 are turned on or off as follows: SW1 off; SW2 on; sc1 on; and sc2 off, as shown in (i), (j), (m), and (n) of FIG. 8, respectively. The switches are controlled externally. However, control circuitry may be provided in the solid state imaging device shown in FIG. 7.

These switching operations activate the source follower (current source 77 in FIG. 7) connected to the source of the ring-gate MOSFET 63. The source follower then raises the source potential of the MOSFET 63 to S2 (=Vg1−Vth1), as shown in (l) of FIG. 8, during the period (4). The potential Vth1 is a threshold-level potential of the MOSFET 63 having holes stored in the backgate (the source-vicinity p₋type region 47 in FIG. 6). The source potential S2 is then stored in the capacitor C1 (FIG. 7) through the turned-on switch sc1.

In the succeeding period (5) in FIG. 8, the potential at the ring gate electrode 45 (FIG. 6) of the ring-gate MOSFET 63 (FIG. 7) is raised to High1 from Vg1, as shown in (k) of FIG. 8. This potential increase is triggered by a control signal supplied from the ring gate potential controller 70 through the ring gate wiring 69. Simultaneously with this potential increase, the switches SW1 and SW2 are turned on and off, as shown in (i) and (j) of FIG. 8, respectively, with the source potential (MOSFET 63) supplied from the source potential controller 75 being raised to Highs, as shown in (l) of FIG. 8.

The potentials High1 and Highs may or may not be the same level but at least both higher than Low1, preferably, High1 and Highs≦Vdd for simpler design or High1=Highs=Vdd, the easiest settings. More preferably, these potentials are set to levels at which the ring-gate MOSFET 63 (FIG. 7) is not turned on so that no currents flow therethrough. The turned-off MOSFET 63 allows increase in potential at the source-vicinity p₋type region 47 (FIG. 6) so that the holes stored in the region 47 are discharged into the p₋type epitaxial layer 42, breaking through the barrier of the n-well 43. This is a reset operation.

The succeeding period (6) in FIG. 8 is also a signal reading period like the period (4). Nevertheless, in the period (6), different from the period (4), the switches sc1 and sc2 are turned off and on, as shown in (m) and (n) of FIG. 8, respectively. The potential at the ring gate electrode 45 (FIG. 6) of the ring-gate MOSFET 63 (FIG. 7) is lowered to Vg1 from High1, as shown in (k) of FIG. 8. In contrast, the source potential of the MOSFET 63 is lowered to SO (=Vg1-Vth0) from Highs in the period (6), as shown in (l) of FIG. 8. This is because the holes stored in the source-vicinity p₋type region 47 have been discharged into the p⁻-type epitaxial layer 42 during the preceding period (5) and thus no holes are stored in the region 47. The potential Vth0 is a threshold-level potential at the ring-gate MOSFET 63 having no holes in the backgate (region 47).

The source potential SO of the MOSFET 63 (FIG. 7) is stored into the capacitor C2 through the turned-on switch sc2. A potential difference (Vth0-Vth1) between the capacitors Cl and C2 is output via the differential amplifier 78. As defined above, Vth0 is a threshold-level potential at the ring-gate MOSFET 63 having no holes in the backgate (p₋type region 47 in FIG. 6) whereas Vth1 is another threshold-level potential at the MOSFET 63 having holes stored in the backgate. Thus, the output (Vth0-Vth1) is a variation in potential due to hole charging.

The output switch swt is then turned on in response to a t-th-column output pulse, shown in (o) of FIG. 8, which is one of “n” output pulses, shown in (f) of FIG. 8, from the horizontal shift register 79. While the output switch swt is on, the potential variation generated by the differential amplifier 78 due to hole charging is output from the CMOS image sensor, as an output signal Vout from the pixel 62 on the t-th column, as indicated by a hatching zone in (p) of FIG. 8.

During the succeeding period (7) in FIG. 8, the potential at the ring gate electrode 45 (FIG. 6) of the ring-gate MOSFET 63 (FIG. 7) is set to Low, as shown in (c) of FIG. 8. This is another waiting mode for the pixel 62, with no holes stored in the source-vicinity p₋type region 47 (FIG. 6). The waiting mode continues until the completion of signal processing, or the signal reading operation to the pixels on the (s+1)-th to m-th lines for the present frame. During this signal reading operation, electron-hole pairs are generated due to photoelectric conversion, and holes thus generated are stored in the buried p⁻-type region 49 (FIG. 6) of the buried photodiode 50 (FIG. 6) or 64 (FIG. 7) during the next period (1a) for the posterior frame. The charge transfer operation to the posterior frame starts in the next period (2a) on completion of the signal reading operation to all pixels in the “m” lines and “n” columns to gain output signals Vout, as shown in (g), for the present frame.

The solid state image sensing device shown in FIG. 6 is one type of CMOS image sensor in which the ring-gate MOSFET 63 having the ring gate electrode 45 is an MOSFET for use in amplification which is provided in each pixel, as shown in FIG. 7.

Moreover, this CMOS image sensor functions as a global shutter in which holes stored during the period (1) in FIG. 8 are transferred from the photodiode 50 (FIG. 6) or 64 (FIG. 7) to the source-vicinity p₋type region 47 (FIG. 6) simultaneously for all pixels during the period (2) in FIG. 8.

Furthermore, there is an option for the reset operation in the period (5) in FIG. 8 in which the source potential of the ring-gate MOSFET 63 (FIG. 7) is raised to Highs, as shown in (l) of FIG. 8, by the source potential controller 75. In detail, the switches SW1 and SW2 are turned off so that the source electrode wiring 74 is placed in a floating state during the period (5). In this floating state, the potential High1 is supplied through the ring gate wiring 69 from the ring gate potential controller 70 to turn on the ring-gate MOSFET 63 in which a current flow from the drain to source raises the source potential. The turned-off MOSFET 63 allows increase in potential at the source-vicinity p₋type region 47 (FIG. 6) so that holes stored in the region 47 are discharged into the p⁻-type epitaxial layer 42 (the reset operation), breaking through the barrier of the n-well 43. The source potential of the ring-gate MOSFET 63 is High1−Vth0: High1 is the gate potential of the MOSFET 63 shown in (k) of FIG. 8; and Vth0 is a threshold-level potential of the MOSFET 63 having no holes in the backgate (p₋type region 47). This option allows reduction of the chip area for the source potential controller 75 because the controller 75 does not require transistors for supplying the potential Highs.

The circuitry for the pixel 62 is shown in a simplified form in FIG. 7. What is omitted in FIG.7 is a switch which should be provided between the source of the transfer-gate MOSFET 65 and the backgate of the ring-gate MOSFET 63. This switch is controlled according to the potentials Low1 and Low2 on the ring gate wiring 69 and the transfer gate wiring 71, respectively. In detail, the switch is turned on at Low1≦Low2 whereas off at Low1>Low2.

When the switch is turned off under one requirement Low1>Low2 in which a substrate potential under the ring gate 45 (at the potential Low1) is higher than another substrate potential under the transfer gate 51 (at the potential Low2), the former substrate potential prevents holes from reaching the source-vicinity p₋type region 47 in FIG. 6.

In contrast, the other requirement Low1≦Low2 is met by the potential controllers 70 and 72, so that the switch is turned on to achieve the connection between the MOSFETs 63 and 65, as shown in FIG. 7. Thus, the switch discussed above is omitted from FIG. 7.

According to the solid state image sensing device disc1osed above, exposure is performed for a period of one frame with no off timing for all lines in each frame, which corresponds to the period (1) in FIG. 8. Charges (holes) stored in each pixel in one frame during the period (1) are transferred to a specific region in each pixel (the backgate of the ring-gate MOSFET 63 in FIG. 7, or the source-vicinity p₋type region 47 in FIG. 6) via the transfer-gate FET 65, simultaneously for all pixels during the period (2) in FIG. 8. Then, signals are read from the pixels sequentially during the periods (3) to (7) in FIG. 8.

Therefore, the solid state image sensing device according to the present invention achieves simultaneous transfer of charges while sequential signal output, thus providing pictures with no distortion even when imaging a moving object.

According to the solid state image sensing device of the present invention, the first well in which the pixel area is provided and each second well in which the MOS-type circuitry is provided are isolated from each other. This well isolation does not allow potential variation occurred in the MOS-type circuitry to be directly transferred to the pixel area, which minimizes adverse effects to the pixel area due to parasitic capacitive coupling. Thus, signals with high quality, such as high S/N, are gained from the pixel area.

Moreover, according to the solid state image sensing device of the present invention, the first well in which the pixel area is provided is formed with lower impurity concentration than each second well in which the MOS-type circuitry is provided, thus enhancing photoelectric conversion efficiency, whereas higher impurity concentration for each second well enhancing short-channel effect reduction and device isolation, under a process rule for further microfabrication.

The present invention is not limited to the embodiment disc1osed above. It will be apparent for th0se skilled in the art that various modifications and variations may be made with0ut departing from the scope of the present invention. For, example, the conductive types, such as, a p₋type and an n-type may be inverted with electrons as charges at inverted potentials, which also provides the same advantages as discussed above.

What is claimed is:

1. A solid state image sensing device comprising:
a substrate of a first conductive type;
a first well and at least one second well formed on the substrate, the first and second wells being of a second conductive type different from the first conductive type, the first and second wells being isolated from each other, the second well being formed with higher impurity concentration than the first well;
a pixel area with multiple pixels provided in the first well, the pixel area including at least a photoelectric conversion region of the first conductive type, provided for each pixel, for storing charges generated due to photoelectric conversion, a source region, and a drain region, the source and drain regions being provided for a signal output transistor, provided for each pixel, that outputs a signal based on the charges;
a charge transferee, provided for each pixel, for transferring the charges to the signal output transistor; and
MOS-type circuitry provided in the second well.

2. The solid state image sensing device according to claim 1, wherein the first and second wells have MOSFETs formed therein, the MOSFETs in the first well having a longer gate length than the MOSFETs in the second well.

3. The solid state image sensing device according to claim 1, wherein the MOS-type circuitry includes a potential controller for controlling the signal output transistor or the charge transferee.

4. The solid state image sensing device according to claim 1, wherein the MOS-type circuitry includes a CDS unit for applying correlated double sampling to the signal output from the signal output transistor.

5. The solid state image sensing device according to claim 4 further comprising an amplifier, formed in MOS-type circuitry in another second well, for amplifying a signal output by the CDS unit.

6. The solid state image sensing device according to claim 5 further comprising an AD converter, formed in MOS-type circuitry in still another second well, for converting a signal output by the amplifier into a digital signal.

7. The solid state image sensing device according to claim 6 further comprising a signal processor, formed in MOS-type circuitry in further second well, for processing the digital signal.

8. The solid state image sensing device according to claim 1 further comprising charge transferers and signal output transistors provided for all pixels in the pixel area, whereby charges stored in photoelectric conversion regions provided for the pixels, when the photoelectric conversion regions are exposed to light, are simultaneously transferred from the charge transferers to the signal output transistors which then sequentially output signals based on the charges.

9. The solid state image sensing device according to claim 1, wherein the signal output transistor includes a ring gate electrode provided above the first well with an insulating film provided therebetween, the drain region being provided as electrically connected to the first well, the source region being provided in the first well so as to meet the center of the ring gate electrode, with a semiconductive region of the first conductive type provided in the first well and in the vicinity of the source region but apart from the drain region.

10. The solid state image sensing device according to claim 9, wherein the charge transferer includes a transfer gate provided above the first well with the insulating film, between the ring gate electrode and the photoelectric conversion region.
